(19) United States
(12) Patent Application Publication
(10) Pub. No.: US 2004/0071306 A1
(43) Pub. Date: Apr. 15, 2004

(54) Hearing aid device with a voltage source

(76) Inventor: Birgit Kufner, Uttenreuth (DE)

Correspondence Address: SCHIFF HARDIN, LLP, PATENT DEPARTMENT, 6600 SEARS TOWER, CHICAGO, IL, 60606-6473, US

(21) Appl. No.: 10/630,096

(22) Filed: Jul. 30, 2003

(30) Foreign Application Priority Data
Jul. 30, 2002 (DE) 102 34 713.1

(51) Int. Cl. H04R 25/00

(52) U.S. Cl. 381/323; 381/322

(57) ABSTRACT

The batteries used to supply voltage in th hearing aid devices are subject to a self-discharge. This is in particular relatively likely given a zinc-air battery. Oxygen that is supplied from outside via the surrounding air is required for the progression of chemical processes in the zinc-air battery. The invention provides a way by which, given a battery inserted in a hearing aid device, a gas exchange between the battery and the surrounding air can be prevented. If the oxygen supply to the battery is stopped, the self-discharge process also comes to a halt. The battery must not therefore be removed from the hearing aid device to prevent the self-discharge, and the hearing aid device also remains ready for use after a long period without use.

### FIELD OF THE INVENTION.

The invention concerns a hearing aid device with a hearing aid device housing and a voltage source with a voltage source housing, whereby the voltage source comprises at least one ventilation opening for ventilation in the voltage source housing.

### DESCRIPTION OF THE RELATED ART

Zinc-air batteries are commonly used as a voltage source for supplying voltage in hearing aid devices. These batteries require oxygen for the chemical reaction such that a ventilation of the battery is necessary. For this purpose, the battery housing respectively comprises at least one ventilation opening. However, a plurality of ventilation openings are typically present in the housing of a zinc-air battery.

In order that the oxygen can reach the battery installed in the hearing aid device, at least one ventilation opening is also provided in the housing of the hearing aid device. As a rule, the leaks present in the housing is sufficient for this purpose, such that no special ventilation openings are necessary.

Zinc-air batteries are subject to a strong self-discharge that can, however, be prevented as long as the ventilation of the batteries is prevented. Zinc-air batteries are therefore for the most part provided with an adhesive label for storage-that closes the ventilation openings and prevents a gas exchange with the ambient air, in particular an entry of oxygen into the battery. In a new and unused battery, this adhesive label is only removed immediately prior to the insertion of the battery into the hearing aid device.

If a hearing aid device with an installed battery is not used for a long time, the battery must again be removed from the hearing aid device and the ventilation opening of the battery closed to prevent the self-discharge. Within a short time, the chemical processes within the battery once again come to a stop and the self-discharge is prevented. The disadvantage in this procedure is that the battery must be very frequently removed from and again inserted into the hearing aid device, in particular when the appertaining hearing aid device is not permanently worn.

A hearing aid with a battery cover is known from German patent document DE 195 02 994 C2, having a through access in which a filter 25 is located, which lets air pass to a zinc-air cell but prevents the penetration of water.

### SUMMARY OF THE INVENTION

The object of the present invention is to prevent the self-discharge in a battery installed in a hearing aid device.

This object is achieved in a hearing aid device with a hearing aid device housing and a voltage source with a voltage source housing, whereby the voltage source comprises at least one ventilation opening for ventilation in the voltage source housing, in that the hearing aid device comprises a mechanism to enable or prevent the ventilation of the voltage source.

The invention features the advantage that the self-discharge of the voltage source is largely prevented by the prevention of the ventilation without requiring that the voltage source additionally be removed from the hearing aid device and closed air-tight. The voltage source can therefore remain in the hearing aid device, even when it is not used for some time.

### DESCRIPTION OF THE DRAWINGS

Further details and advantages of the invention arise from the subsequent description of the exemplary embodiments. Thereby shown are:

FIG. 1 is a pictorial diagram of a hearing aid device worn behind the ear with a battery chamber in which is arranged a battery with ventilation openings;

FIG. 2 is a cross-sectional view of a sub-region of the hearing aid device according to FIG. 1 in an activated state and with opened ventilation openings;

FIG. 3 is a cross-sectional view of a sub-region of the hearing aid device according to FIG. 1 in a deactivated state and with closed ventilation openings;

FIG. 4 is a pictorial diagram of a hearing aid device worn behind the ear with a seal element to open or close the ventilation openings of the battery;

FIG. 5 is a pictorial diagram of a hearing aid device worn behind the ear with an encapsulated battery chamber and with a ventilation device;

FIG. 6 is a pictorial diagram of a hearing aid device worn behind the ear with an encapsulated battery chamber, a ventilation channel, and a valve;

FIG. 7 is a pictorial diagram of a hearing aid device worn behind the ear with an on/off switch fashioned as a sliding element, and

FIG. 8 is a cross-sectional view of a sub-region of a hearing aid device worn behind the ear with a seal element.

### DETAILED DESCRIPTION OF THE PREFERRED EMBODIMENTS

An embodiment of the invention directly closes the (or every) ventilation opening of the voltage source installed in the hearing aid device, such that the chemical processes within the voltage source come to a halt and the self-discharge of the voltage source in the deactivated hearing aid device is prevented.

A hearing aid device according to an embodiment of the invention preferably comprises at least one seal element that: a) can be moved relative to the voltage source housing, b) closes the ventilation opening in a first position, and c) uncovers the ventilation opening in a second position. The seal element can likewise also be anchored in the hearing aid device housing, and the voltage source may be moved in the cited motion directions relative to the seal element.

The seal element is preferably fashioned to close a voltage source with a plurality of ventilation openings such that a one-piece seal element can simultaneously open and close all ventilation openings of the voltage source. The seal element can be turned or moved laterally over the ventilation openings. Furthermore, it is possible that the seal element, to close the ventilation openings, may be moved vertically onto or lifted off therefrom.

In a further embodiment of the invention, the mechanism to open or close the ventilation opening of the voltage source comprises a turning or sliding element that can be operated by the hearing aid user. The turning or sliding element is preferably provided on the respective underside with a seal that is guided over the ventilation opening and closes it. The ventilation opening can thus be closed or uncovered by operation of the turning or sliding element. An indirect connection between the turning or sliding element operable by the hearing aid user and a seal element to open or close the ventilation opening is also possible. For example, given operation of the turning or sliding element, the seal element can be moved over the ventilation opening using a spring actuation.

In a preferred embodiment of the invention, the mechanism to open or close the ventilation opening are connected with an operable on/off switch for the hearing aid device such that the ventilation opening are closed given a deactivated hearing aid device and open given an activated hearing aid device. A mechanical connection also preferably exists between the on/off switch for the hearing aid device and the seal element to open or close the ventilation opening.

An alternative embodiment provides a mechanism to automatically open and close the (every) ventilation opening. The ventilation opening can thus be opened upon activation of the hearing aid device and closed upon deactivation of the hearing aid device using a miniature electrical and/or magnetic actuator.

In an embodiment of the invention, the voltage source may be arranged in a rotatable or turnable battery chamber with the hearing aid device. The (every) ventilation opening of the voltage source is open in the closed position of the battery chamber Furthermore, a second, preferably latching, position of the battery chamber is provided in which the ventilation opening is closed and in which the voltage source can not be removed from the hearing aid device. Finally, in a third position, the battery chamber is opened and the voltage source can be removed from it. The battery chamber thus fashioned preferably functions at the same time as an on/off switch for the hearing aid device. In the first position of the battery chamber, the hearing aid device is activated, in the second and third positions the battery chamber is deactivated.

In another embodiment of the invention, the voltage source inside the hearing aid device is arranged encapsulated in a battery case, i.e., separated airtight from the remaining interior of the hearing aid device and from the ambient air in the hearing aid device. An air exchange with the ambient air can thus only ensue in an installed voltage source via a ventilation device present in the hearing aid device that forms an opening from the battery case through the hearing aid device housing to the outside. According to the invention, this connection can also preferably be interrupted by a mechanism to enable or prevent the ventilation of the battery case.

The hearing aid device preferably comprises a seal element that can be operated by the user of the hearing aid device to open or close the ventilation device. The ventilation device can be fashioned as an opening in the housing of the hearing aid device that can be opened or closed by using the seal element. Furthermore, it is possible that a ventilation channel leads from the voltage source to the housing of the hearing aid device and connects with a housing opening. The seal element can then also directly affect this ventilation channel and open or close it at an appropriate position.

The seal element is preferably fashioned as a turning or sliding element that closes or uncovers the ventilation opening or the ventilation channel via a turning or sliding motion. Furthermore, the hearing aid device can also comprise a valve, in particular in connection with a ventilation channel to ventilate the voltage source, that likewise uncovers the ventilation channel in an open position and closes the ventilation channel in a closed position,

In an embodiment of the invention, the voltage source is arranged connected with the hearing aid device in a rotatable or turnable battery chamber that is provided with seal elements such that it encloses the voltage source in at least a substantially airtight manner at a particular position of the battery chamber relative to the hearing aid device housing, In a first position, the battery chamber is closed and the hearing aid device is switched on. Furthermore, a gas exchange ensues between the voltage source arranged in the battery chamber and the air surrounding the hearing aid device, in particular an ingress of oxygen into th voltage source. In a second, preferably latchable position, the hearing aid device is turned off and the voltage source is encapsulated from its surroundings according to the embodiment, whereby an existing ventilation opening or ventilation channel is shut. In a third position, the battery chamber is opened and the voltage source can be removed.

As in the cited embodiment with a battery chamber with a plurality of different functions, each according to its position relative to the hearing aid device housing, the turning or sliding element can similarly be fashioned as an on/off switch for the hearing aid device in the embodiments with a turning or sliding element. The ventilation of the voltage source is then enabled or prevented via operation of the turning or sliding element. Ventilation openings are likewise also preferably directly opened or closed via operation of a turning or sliding element for opening or closing contacts to switch the hearing aid device on or off.

Another variant of the invention provides that the mechanism to open or close the ventilation device are not directly connected with the on/off switch. To open or close the ventilation device, the hearing aid device comprises a miniature electrical and/or magnetic actuator that automatically opens or closes the ventilation device via operation of the on/off switch.

A further embodiment of the invention provides a sealing device that encloses the (every) ventilation opening of the voltage source in an at least substantially airtight manner. This embodiment is in particular advantageous given voltage sources with a plurality of ventilation openings, in that the sealing device is attached to the outside of the voltage source and thus closes all ventilation openings of the voltage source together. The sealing device furthermore provides an opening facing away from the battery that can be opened or closed, and thus enables or prevents ventilation of the voltage source. Various possibilities to open or close the last named opening are also possible in this embodiment. A turning or sliding element or a valve can also thus be used. The mechanism to open and close the opening is also preferably connected to the on/off switch for the hearing aid device. Thus, on the one hand, a direct mechanical connection can exist, however a mechanism can also exist to automatically open or close the opening via operation of the on/off switch.

Also provided in this embodiment may be a variant of a rotatable or turnable battery chamber connected to the hearing aid device, arranged inside the voltage source. The battery chamber may also preferably fashioned similar to an on/off switch for the hearing aid device, and the sealing device configured to uncover the opening given an activated hearing aid device or close it given a deactivated hearing aid device.

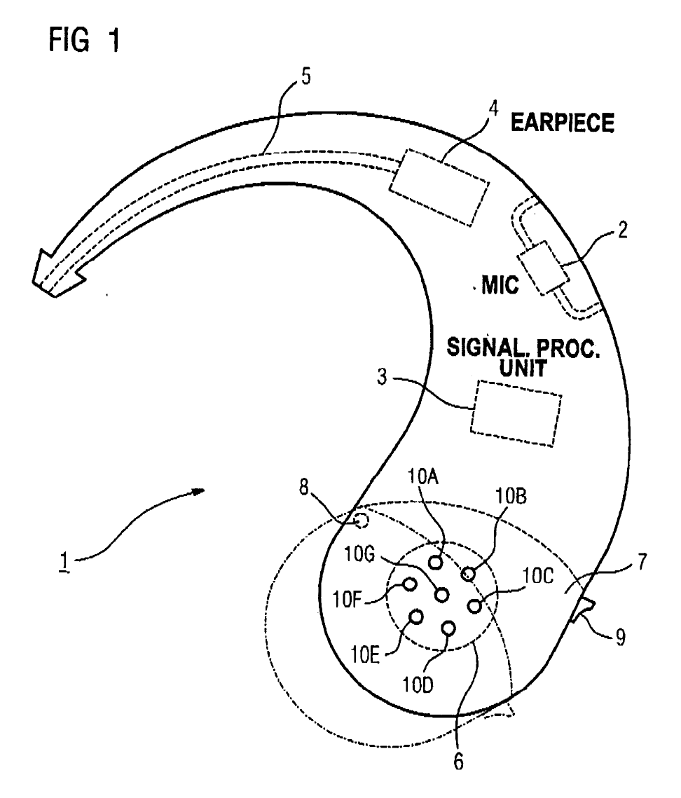

Referring to the drawings showing the exemplary embodiments, FIG. 1 shows in a schematic, very simplified representation a hearing aid device (HdO) 1 worn behind the ear with a microphone 2 to acquire an acoustic Input signal and transduce it into an electrical signal. This is supplied to a signal processing unit 3 for processing and amplification of the electrical output signal of the microphone, Finally, the processed and amplified signal is supplied to an earpiece 4 for transduction back into an acoustic signal. The acoustic output signal of the earpiece is emitted in the auditory canal of a hearing aid user via a sound channel 5 and a sound tube (not shown).

The electrical components of the hearing aid device 1 worn behind the ear are connected with a battery 6 to supply voltage. This is located in a battery chamber 7 connected with the hearing aid device 1 worn behind the ear, such that it can be turned. To turn the battery chamber 7, the hearing aid comprises a hinge 8 as well as an operating element 9. The battery chamber 7 may serve both to insert and remove the battery in an open position of the battery chamber 7 and to turn the hearing aid device on and off. For this purpose, the battery chamber 7 can take up a second latchable position (dashed line in FIG. 1), in which the hearing aid device is deactivated but the voltage source can not be removed. To remove the battery 6, it must be swiveled out of the housing of the hearing aid device 1 along with the battery chamber 7.

The battery chamber 7 is located in the closed position (solid line) in FIG. 1. In this position, the battery 6 is contacted to supply voltage to the electrical components of the hearing aid device 1. To ventilate the battery, ventilation channels that meet in the ventilation openings 10A-10G In the hearing aid device housing are arranged between the battery 7 and the housing of the hearing aid device 1. A gas exchange can thus ensue between the battery 6 and the air surrounding the hearing aid device 1 upon operation of the hearing aid device 1.

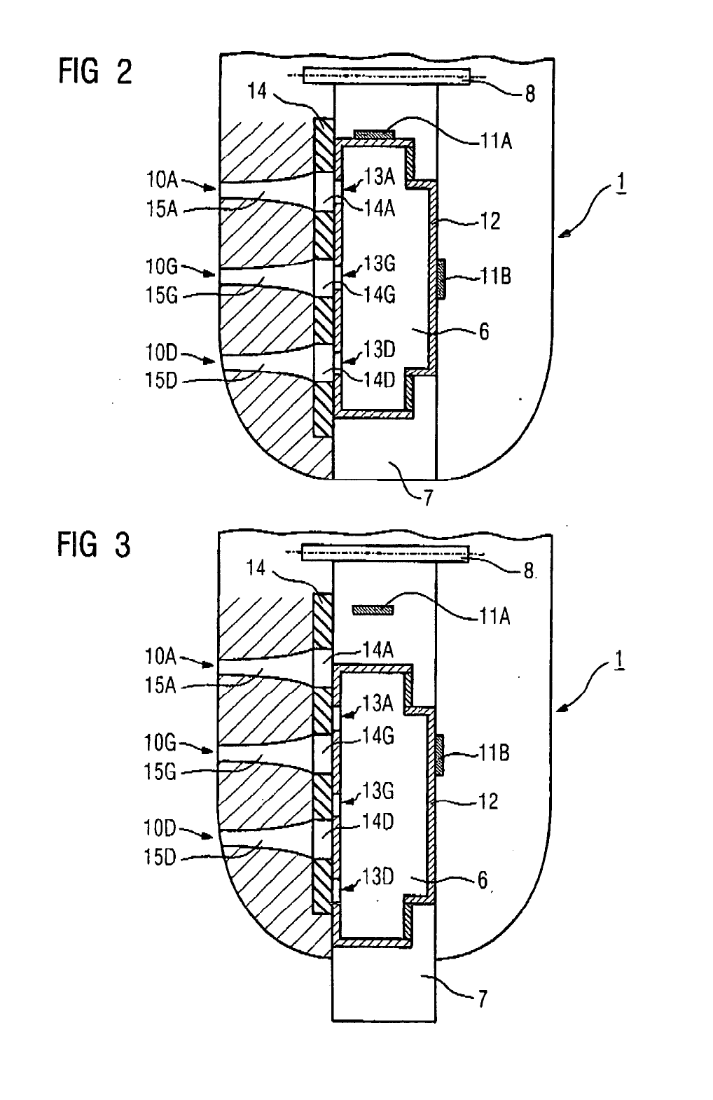

FIG. 2 likewise shows a schematic, very simplified representation of the lower housing end of the hearing aid device 1 according to FIG. 1, in which the battery 6 is arranged in a battery chamber 7. The hearing aid device 1 comprises electrical contact elements 11A and 11B to contact the battery 6. In the shown position of the battery chamber 7, the electrical contact elements 11A and 11B in the housing 12 lie against the battery. The hearing aid device 1 is thereby activated. A gas exchange with the air surrounding the hearing aid device 1 is necessary for the progression of the chemical processes inside the battery 6. For this purpose, ventilation openings 13A-13G are located in the housing 12 of the battery 6, of which, however, only the ventilation openings 13A, 13D, and 13G are visible in FIG. 2. The number and arrangement of the ventilation openings in the housing 12 of the battery 6 correspond to the number and arrangement of the ventilation openings 10A-10G in the housing of the hearing aid device 1 according to FIG. 1. Therefore, only the ventilation openings cited above are to be inferred from the cross-section representation according to FIG. 2.

Given a closed battery chamber 7, a seal 6 lies against the battery 6 in sealed fashion on the housing side of the housing 12 with the ventilation openings 13A-13G. The seal 14 is provided with openings 14A-14G that continue via ventilation channels 15A-15G to the ventilation openings in the housing of the hearing aid device 1. A gas exchange between the battery 6 and the air surrounding the hearing aid device 1 can thus ensue in the shown position of the battery 6 in the hearing aid device 1.

Ordinarily, the housing of a hearing aid device is not closed air-tight, such that, in an alternative variant of the invention (not shown), the ventilation openings 10A-10G in the housing of the hearing aid device, as well as the ventilation channels 15A-15G between the seal 14 and the ventilation openings 10A-10G, can be dispensed with.

FIG. 3 shows the same arrangement as FIG. 2, however in a deactivated hearing aid device 1. In this switch position, the battery chamber 7, the battery chamber 7 is turned a certain distance around the axis 8 and is latched in this second latchable position of the battery chamber 7. In the shown position of the battery chamber 7, the electrical contact element 11A no longer lies against the housing 12 of the battery 6, whereby the supply of electrical voltage is interrupted and the hearing aid device 1 is deactivated. The battery 6 in this switch position is still located at least primarily in the housing of the hearing aid device 1, and cannot also be removed from it in this switch position, As is visible in FIG. 3, the ventilation openings 13A-13G in the housing 12 of the battery 6 are no longer located over the openings 14A-14G in the seal 14, such that the gas exchange is prevented and the chemical processes inside the battery 6 come to a halt. A self-discharge of the battery 6 is thereby prevented.

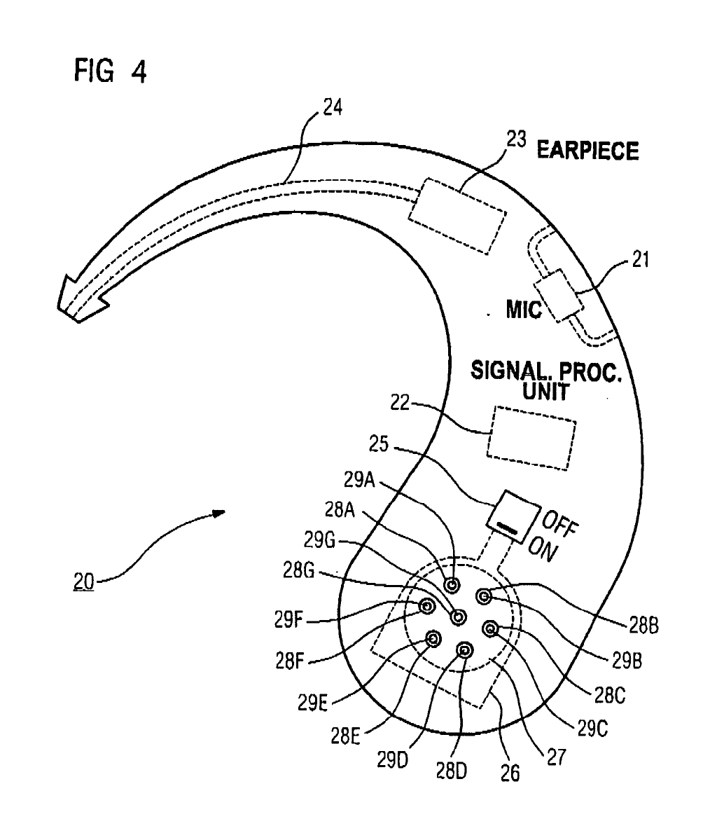

FIG. 4 shows a further exemplary embodiment of the invention. This exemplary embodiment also concerns a hearing aid device 20 worn behind the ear, with a microphone 21, a signal processing unit 22, an earpiece 23, as well as a sound channel 24. The mode of operation of the hearing aid device shown in FIG. 4 corresponds to that of the hearing aid device according to FIG. 1,

In contrast to the exemplary embodiment according to FIGS. 1 through 3, however, a separate on/off switch 25 is provided in the hearing aid device according to FIG. 4 that is not operated via the battery chamber. The two switch positions “ON” and “OFF” are possible with the on/off switch 25. Firmly connected to on/off switch 25 is a moveable seal element 26 that is arranged between a battery 27 and the hearing aid device housing and pushed against the battery 27 located in the hearing aid device. Furthermore, the seal element comprises openings 28A-28G that, in the activated state of the hearing aid, lie over ventilation openings 29A-29G of the battery 27 and thus form a connection between the ventilation opening 29A-29G) of the battery 27 and ventilation openings in the hearing aid device housing (not shown). The ventilation openings in the hearing aid device housing normally result from the pre-existing leakiness in the hearing aid device housing such that no special devices are provided for this purpose If the on/off switch of the hearing aid device is set in the “OFF” position, the ventilation openings 29A-29G of the battery 27 are thus thereby closed. A gas exchange with the air surrounding the hearing aid device can thus no longer ensue, and the self-discharge of the battery 27 is stopped.

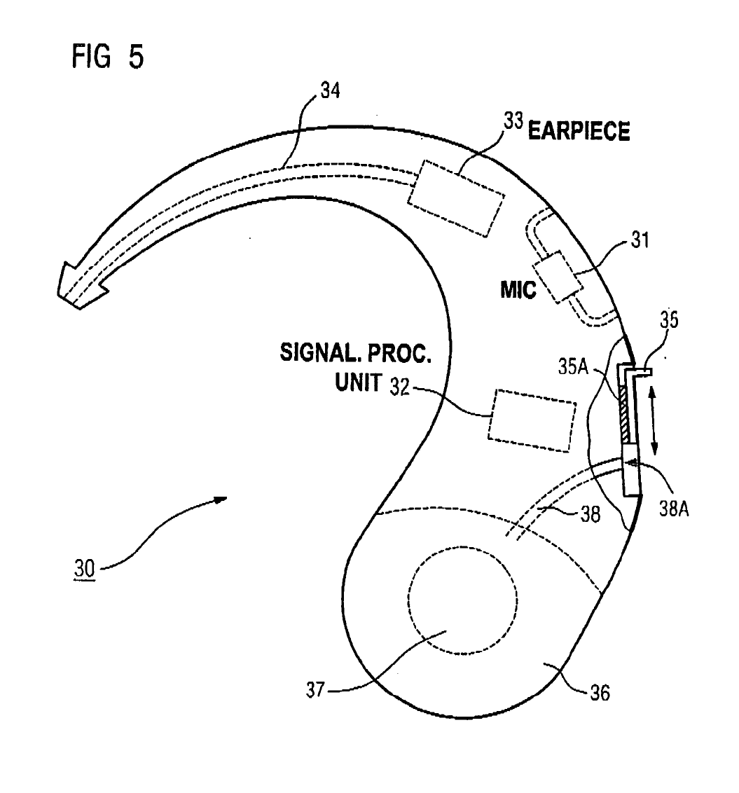

The further exemplary embodiment according to FIG. 5 also concerns a hearing aid device (HdO) worn behind the ear with a microphone 31, a signal processing unit 32, an earpiece 33, and a sound channel 34 with the mode of operation indicated in FIG. 1. However, in contrast to the exemplary embodiment according to FIG. 1, the hearing aid device 30 according to FIG. 5 comprises an on/off switch 35 to activate and deactivate the hearing aid device 30. The on/off switch 35 is fashioned as an operable sliding element with two switch positions. The hearing aid device 30 is activated in the switch position “ON” and deactivated in the switch position “OFF”.

A further difference with the previously indicated exemplary embodiments is that the hearing aid device 30 comprises a battery chamber 36 that can at least substantially be closed air-tight, in which the battery 37 is arranged to supply voltage to the hearing aid device 30. The battery chamber 36 is preferably provided with seal elements (not shown) in the transition region to the hearing aid device housing for encapsulating the battery. Furthermore, according to the embodiment, a ventilation channel 38 that begins in the battery chamber 36 and meets the ventilation opening 38A is provided to ventilate the battery 37. The ventilation opening 38A is open (switch position “ON”) or closed (switch position “OFF”) for each of the current switch positions of the on/off switch 35. A seal 35A that closes the ventilation opening 38A air-tight in the switch position “OFF” is preferably located in the underside of the on/off switch 35.

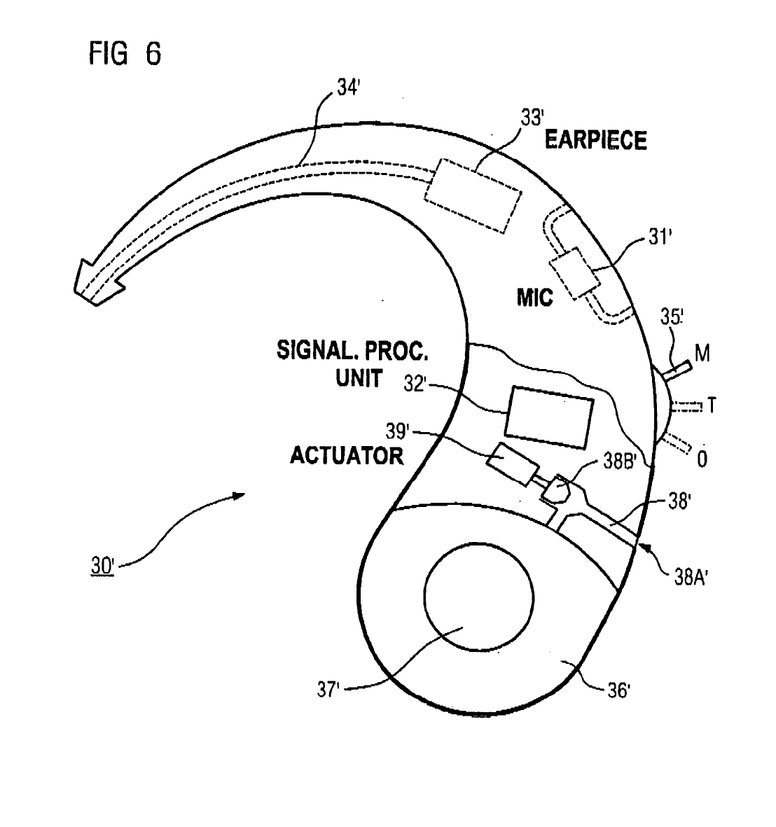

The subsequent exemplary embodiment according to FIG. 6 also concerns a hearing aid device 30′ worn behind the ear with a microphone 31′, a signal processing unit 32′, an earpiece 33′, as well as a sound channel 34′, However, in contrast to the exemplary embodiment according to FIG. 5, the hearing aid device 30′ according to FIG. 6 comprises an MTO switch 35′ to operate the hearing aid device 30′. The hearing aid device 30′ is activated in the switch position “M”, and the signal acquisition ensues via the microphone 31′. The hearing aid device 30′ is likewise activated in the switch position “T”, however the signal acquisition does not ensue via the microphone 31′, but rather inductively via a telephone coil (not shown). The hearing aid device 30′ is deactivated In the switch position “O”.

The hearing aid device 30′ also comprises a battery 37′ in a battery chamber 36′ closed air-tight, to provide voltage to the hearing aid device 30′. According to the invention, a ventilation channel 38′ that begins in the battery chamber 36′ and meets a ventilation opening 38A′ in the housing of the hearing aid device 30′ is provided to ventilate the battery 37′. In contrast to the exemplary embodiment according to FIG. 5, a valve 38B′ to open and seal the ventilation channel 38′ is located in the ventilation channel 38′ in the exemplary embodiment according to FIG. 6. The valve 38B′ is connected with a miniature electric actuator that holds the valve 38B′ in the open state in the switch positions “M” and “T” of the MTO switch and, given a deactivated hearing aid device 30′ (switch position “0”), moves the valve 38B′ to its closed position.

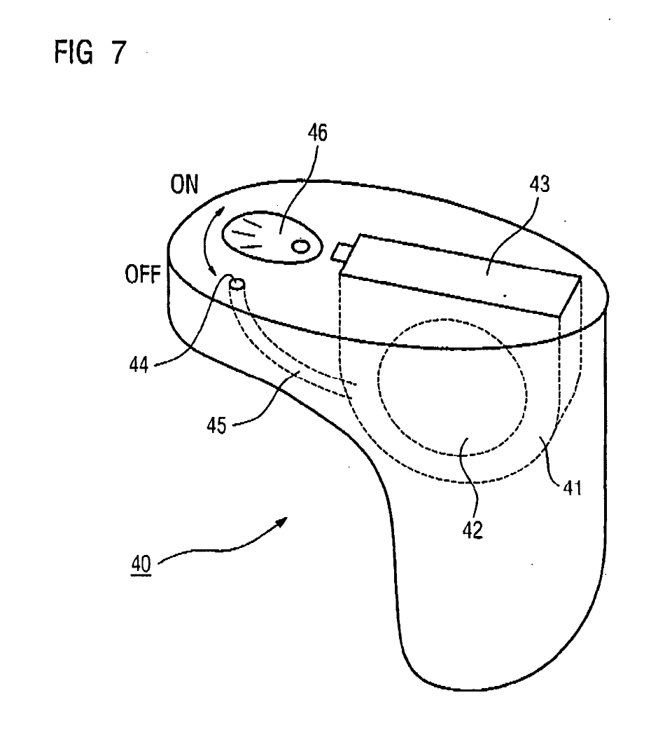

FIG. 7 shows a further exemplary embodiment of the invention. Different than the preceding exemplary embodiments, it concerns a hearing aid device (IdO) 40 worn in the ear. Therefore, only the components of the hearing aid device 40 worn in the ear that are important for this embodiment are shown in FIG. 7. Consequently, this embodiment also comprises a battery 42, arranged in a battery case 41 inside the hearing aid device 40, accessible via a battery cover 43 in the housing of the hearing aid device 40 worn in the ear.

In this exemplary embodiment, the battery case is also closed from the remaining internal space of the hearing aid device 40 as well as from the air surrounding the hearing aid device 40, such that a ventilation of the battery can only ensue via a ventilation device provided for this purpose. For this purpose, the hearing aid device 40 worn in the ear in the exemplary embodiment according to FIG. 7 comprises a ventilation channel 45 between the battery 42 and a ventilation opening 44 in the housing of the hearing aid device 40. A gas exchange between the battery 42 and the air surrounding the hearing aid device 40 can ensue via the ventilation channel 45 and the ventilation opening 44.

In order that a gas exchange only ensues given an activated hearing aid devic 40, an on/off switch 46 of the hearing aid device 40 is fashioned as a turn element that uncovers the ventilation opening 44 In the activated switch position (ON) of the hearing aid device 40, as is shown in FIG. 7. If the on/off switch 46 of the hearing aid device 40 moved to the deactivated switch position (OFF), it thus slides over the ventilation opening 44 and similarly closes it. The gas exchange between the battery 42 and the air surrounding the hearing aid device 40 is consequently prevented and the self-discharge of the battery 42 stopped, The hearing aid device 40 can then also remain unused a long time in this state without requiring that the battery be removed from the hearing aid device 40 and closed in order to prevent a self-discharge. The hearing aid device 40 can then also be immediately reactivated at any time after a long period of nonuse via operation of the on/off switch 46.

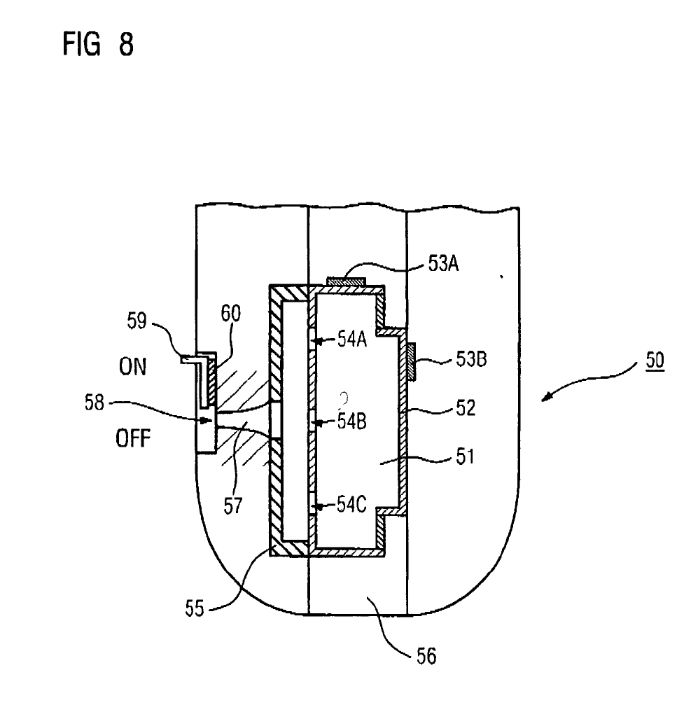

FIG. 8 shows another exemplary embodiment of the invention. As in preceding exemplary embodiments, this also shows a portion of the lower region of a hearing aid device (HdO) 50 worn behind the ear, in which a battery 51 with a housing 52 to provide voltage is applied. To provide voltage, the housing of the battery 51 is connected with contact elements 53A and 53B. Furthermore, ventilation openings 54A-54C exist in the housing 52 to ventilate the battery 51, In addition, a sealing device is provided, by way of which the ventilation of the battery 51 can be enabled or prevented. Different than in the preceding exemplary embodiments, a seal element 55 encloses all ventilation openings 54A-54C together. For this purpose, the seal element 55 lies against the battery 51 solely on the outside, such that the ventilation opening 54A-54C are under a type of “closed bell”.

This is therefore advantageous, in particular since the number and arrangement of the ventilation openings in the battery housing 52 are irrelevant. The seal element 55 is firmly anchored in the hearing aid device, and the battery 51 is swung out of the hearing aid device 51 upon opening the battery chamber 56 or swung into the hearing aid device 50 upon closing the battery chamber 56, and thereby directed over the seal element 55.

To enable or prevent the ventilation of the battery 51 according to th invention, the seal element 55 is connected with a ventilation channel 57 that enables an air exchange between the volume enclosed by the seal element 55 and the battery 51 and the air surrounding the hearing aid device. Furthermore, a ventilation opening 58 of the ventilation device running from the ventilation channel to the outside can be closed upon deactivation of the hearing aid device 50. In addition, an operable on/off switch 50, on whose underside Is arranged a seal 60, Is moved from the position “ON” (activated hearing aid device 50) to the position “OFF” (deactivated hearing aid device).

In summary, the batteries (6, 27, 37, 37′, 51) used to supply voltage in the hearing aid devices (1, 20, 30, 40, 50) are subject to a self-discharge. This is in particular relatively likely given a zinc-air battery. Oxygen that is supplied from outside via the surrounding air is required for the progression of chemical processes in the zinc-air battery, The invention provides a mechanism by which, given a battery (6, 27, 37, 37′, 51) inserted in a hearing aid device (1, 20, 30, 40, 50), a gas exchange between the battery (6, 27, 37, 37′, 51) and the surrounding air can be prevented. If the oxygen supply to the battery is stopped, the self-discharge process also comes to a halt, The battery (6, 27, 37, 37′, 51) must not therefore be removed from the hearing aid device (1, 20, 30, 40, 50) to prevent the self-discharge, and the hearing aid device (1, 20, 30, 40, 50) also remains ready for use after a long period without use.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art. The particular implementations shown and described herein are illustrative examples of the invention and are not intended to otherwise limit the scope of the invention in any way. For the sake of brevity, conventional electronics, control systems, and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections of logical connections may be present in a practical device. Moreover, no item or component is essential to the practice of the invention unless the element is specifically described as “essential” or “critical”. Numerous modifications and adaptations will be readily apparent to those skilled in this art without departing from the spirit and scope of the present invention.

What is claimed is:

1. A hearing aid device, comprising:
a hearing aid device housing;
a voltage source with a voltage source housing, the voltage source comprising at least one ventilation opening for ventilation in the voltage source housing; and
a ventilation mechanism configured to enable or prevent the ventilation of the voltage source.

2. The hearing aid device according to claim 1, wherein the ventilation mechanism comprises an open-close mechanism configured to open or close the ventilation opening of the voltage source.

3. The hearing aid device according to claim 2, wherein the open-close mechanism comprises at least one seal element that can be moved relative to the voltage source that closes the ventilation opening in a first position and uncovers the ventilation opening in a second position.

4. The hearing aid device according to claim 2, wherein the open-close mechanism comprises a turning or sliding element.

5. The hearing aid device according claim 2, further comprising:
an on/off switch;
wherein
the open-close mechanism is connected with the on/off switch for the hearing aid device, such that the ventilation opening is closed given a deactivated hearing aid device and open given an activated hearing aid device.

6. The hearing aid device according to claim 1, wherein the voltage source is arranged in a battery chamber connected to the hearing aid device that can be rotated or turned, and the ventilation opening of the voltage source is opened or closed via the rotation or turning motion of the battery chamber.

7. The hearing aid device according to claim 6, wherein the hearing aid device can be activated or deactivated via the rotating or turning motion of the battery chamber.

8. The hearing aid device according to claim 1, further comprising:
a battery case configured to accept the voltage source that can be sealed in an essentially air-tight manner.

9. The hearing aid device according to claim 8, further comprising:
a battery case ventilation device comprising a battery case ventilation mechanism configured to enable or prevent the ventilation of the battery case;

10. The hearing aid device according to claim 9, wherein the battery case ventilation device comprises at least one adjustable seal element.

11. The hearing aid device according to claim 10, wherein the at least one seal element is fashioned as a turning or sliding element.

12. The hearing aid device according to claim 10, wher in the at least one seal element is fashioned as a valve.

13. The hearing aid device according to claim 8, wherein an on/off switch for the hearing aid device is fashioned as a seal element or is connected with the seal element.

14. The hearing aid device according to claim 13, wherein the on/off switch is configured to automatically adjust the seal element.

15. The hearing aid device according to claim 8, further comprising:
a battery chamber in which the voltage source is arranged, the battery chamber being connected to the hearing aid device and that can be rotated or turned, and the battery chamber is opened or closed at least in an essentially air-tight fashion by the rotating or turning motion.

16. The hearing aid device according to claim 15, wherein the hearing aid device is configured to be activated or deactivated by the rotating or turning motion, the battery chamber being air-permeable given an activated hearing aid device and at least essentially air-tight given a deactivated hearing aid device.

17. The hearing aid device according to claim 1, further comprising:
a sealing device with at least one closeable sealing device opening that encloses the ventilation opening of the voltage source 51; and
an open-close mechanism to open or close the sealing device opening.

18. The hearing aid device according to claim 17, wherein the open-close mechanism comprises a turning or sliding element.

19. The hearing aid device according to claim 17, wherein the open-clos mechanism comprises a valve.

20. The hearing aid device according to claim 17, wherein the open-close mechanism comprises an on/off switch for the hearing aid device.

21. The hearing aid device according to claim 20, wherein the opening is automatically opened or closed via operation of the on/off switch.

22. The hearing aid device according to claim 17, further comprising
a battery chamber in which the voltage source is arranged, the battery chamber being connected to the hearing aid device and that can be rotated or turned, and the opening is opened or closed by a rotating or turning motion.

23. The hearing aid device according to claim 22, wherein the hearing aid device is configured to be activated or deactivated by the rotating or turning motion, the opening being open given an activated hearing aid device and closed given a deactivated hearing aid device.
